(19) United States
(12) Patent Application Publication
(10) Pub. No.: US 2022/0198352 A1
(43) Pub. Date: Jun. 23, 2022

(54) System and Method for Vehicle Relocation

(71) Applicant: Bayerische Motoren Werke Aktiengesellschaft, Muenchen (DE)

(72) Inventors: Irina BENKERT, Muenchen (DE); Felix PRZIODA, Finsing (DE)

(21) Appl. No.: 17/594,618

(22) PCT Filed: Jun. 13, 2019
(86) PCT No.: PCT/EP2019/065488

§ 371 Date: Oct. 25, 2021

(51) Int. Cl. G06Q 10/06; G06Q 30/02

(52) U.S. Cl. CPC G06Q 10/06311; G06Q 30/0202

(57) ABSTRACT

A method for relocating one or more vehicles of a fleet of shared vehicles in an operating area is provided. The operating area includes a plurality of zones, each zone of the plurality of zones being configured to designate a portion of the operating area. The method includes determining, for each zone of the plurality of zones, a relocation requirement for the one or more vehicles based on a predicted demand, the predicted demand including, for each zone of the plurality of zones, a respective demand indicative of a demand for vehicles in the respective zone; determining, based on the respective relocation requirement, the one or more vehicles to be relocated; and providing the one or more vehicles to be relocated with a relocation instruction.

### BACKGROUND AND SUMMARY OF THE INVENTION

The present disclosure relates to systems and methods for relocating vehicles. In particular, the present disclosure relates to systems and methods for relocating vehicles employed in ride hailing or ride sharing applications. The vehicles may include classic or human-operated vehicles as well as automated and/or autonomous vehicles.

The use of on-demand mobility (ODM) services based on a shared fleet of vehicles (e.g. ride hailing, ride sharing, car sharing) has become of increasing importance in serving mobility needs of users in urban populations. Such services typically use online-enabled platforms for connecting users with vehicles, for example autonomous vehicles or vehicles operated by human drivers participating in the on-demand mobility services with their own vehicles. In car sharing applications, users operate the vehicles themselves. ODM services typically provide services similar to those of licensed taxicabs at a lower cost.

One key issue for ODM services is to achieve and/or maintain a uniform and/or other desired distribution of vehicles over a designated operating area in order to ensure that for a prospective user there are one or more vehicles available in the vicinity of the user. In the scope of the present disclosure, the term “vicinity” may refer to different metrics. When applied to car sharing, the term may refer to a distance metric, for example a walking distance between a user and one or more (closest) vehicles. When applied to ride hailing, the term may refer to a time metric, for example an estimated time of arrival (ETA) of a hailed vehicle at the location of a user. Unless expressly specified otherwise, the term vicinity may refer to an applicable metric for the respective use case.

One typical problem for ODM services is that, for example depending on the time of day, user demand fluctuates, thereby often resulting in some regions of the operating area being low on vehicles due to high demand and some other regions of the operating area seeing a higher number of vehicles due to low demand.

Thus, in any fleet of shared vehicles, there is a need for intermittently relocating individual vehicles in order to achieve and/or maintain the desired distribution. Specifically, to ensure such a distribution of vehicles over an operating area, based on the location of the fleet vehicles, one or more vehicles may have to be relocated to a different region of the operating area so that they are accessible to users there. In some cases, this may include driving a vehicle across the operating area. Relocating vehicles may entail substantial costs, for example when autonomous vehicles or human-operated vehicles have to be relocated without a user on board.

U.S. 2015/0310379 A1 describes shared vehicle systems and methods in which a map is generated, indicating respective locations of a plurality of vehicles included in a ride-sharing service. In the plurality of vehicles, a vehicle is identified that needs to be relocated. A user is identified in a vicinity of the identified vehicle for an offer to use the identified vehicle. The offer is transmitted, via a network, to the user for use of the identified vehicle in a manner to support the relocation. The described systems and methods are designed to reduce the number of empty relocations (i.e. without a user) in this manner.

A. G. Santos, P. G. L. Cândido, A. F. Balardino and W. Herbawi, “Vehicle relocation problem in free floating carsharing using multiple shuttles”, 2017 IEEE Congress on Evolutionary Computation (CEC), San Sebastian, 2017, pp. 2544-2551, describe an integer linear programming formulation and an evolutionary algorithm to solve the vehicle relocation problem in free floating carsharing. In the described car sharing system, users rent cars and may leave them anywhere in a designated area. After a while, a set of vehicles must be relocated to a discrete set of weighted spots, where other users may rent them again. In order to achieve the relocation, some shuttles drive a set of operators to vehicles to be relocated and then collect the operators back. The objective is to maximize the weighted sum of served spots at a given time. The integer linear programming model is designed to solve the small instances and to give an upper and a lower bound for others. The upper and lower bound values are used to evaluate the solution found by the evolutionary algorithm and show that the algorithm may find good or optimal solutions.

There exist some approaches to alleviate the effects of an uneven distribution of vehicles and/or to provide for efficient or inexpensive relocation of vehicles. However, a fluctuating demand is typically not considered, such that an insufficient availability of vehicles first has to arise in order to start a relocation of vehicles. Thus, during the time required for a relocation, user requests for transportation may not be fulfilled and users might decide to use an alternative mode of transportation.

Therefore, there is a need for systems and methods based on which a prospective demand can be determined. This may facilitate a more precise and timelier fulfillment of transportation requests and, in turn, lead to a more efficient and effective use of a fleet of shared vehicles. As such, this may further lead to increased revenue of the ODM service.

Further, vehicles may go in and out of service, for example based on vehicle maintenance or a human driver taking a break or starting/ending their shift. In such cases, a vehicle would have to be integrated or removed from an active fleet of shared vehicles without significantly impacting the overall availability of vehicles in a certain region of the operating area.

Therefore, there is a need for systems and methods which enable continuous management of vehicles in a fleet while considering operating procedures of the vehicles and/or schedules of human operators. In particular, the time required to coordinate vehicles and/or drivers at the start of a shift is significantly reduced. Further, control and tracking of vehicles and/or drivers during idle time is facilitated. This may also lead to a more precise and timelier fulfillment of transportation requests and, in turn, lead to a more efficient and effective use of a fleet of shared vehicles.

Moreover, the relocation of vehicles is often not based on the effects of recurring transportation requirements, such as a daily commute or typical transportation patterns of users (e.g. on weekdays, holidays, in the morning, around noon, or in the evening). Relocation may, thus, be triggered with a significant latency between rising or high demand and falling or low supply of vehicles.

Therefore, there is a need for systems and methods which allow for a preemptive relocation of vehicles of a fleet of shared vehicles based on prospective demand and on an overall relocation strategy, which is based on a plurality of vehicles instead of focusing on the relocation of individual or single vehicles. This can lead to a significant overall reduction of relocation costs while allowing for a more efficient and effective use of the vehicles of the fleet. In particular, fuel or energy consumption and associated costs can be reduced and/or optimized. When applied to a fleet of autonomous vehicles, in particular the vehicle movements during idle time may be optimized.

One or more of the objects specified above are substantially achieved by the claimed invention.

In a first aspect according to the invention, there is provided a method for relocating one or more vehicles of a fleet of shared vehicles in an operating area, the operating area including a plurality of zones, each zone of the plurality of zones being configured to designate a portion of the operating area. The method comprises determining for each zone of the plurality of zones a relocation requirement for the one or more vehicles based on a predicted demand, the predicted demand including, for each zone of the plurality of zones, a respective demand indicative of a demand for vehicles in the respective zone; determining, based on the respective relocation requirement, the one or more vehicles to be relocated; and providing the one or more vehicles to be relocated with a relocation instruction.

In a second aspect according to aspect 1, the method further comprises determining for each zone of the plurality of zones the respective predicted demand based on historical data indicative of a use of the vehicles of the fleet of shared vehicles.

In a third aspect according to any one of aspects 1 or 2, the predicted demand includes a plurality of predicted demand values, wherein each predicted demand value is associated with a time slot of a plurality of time slots.

In a fourth aspect according to aspect 3, the plurality of time slots is configured to represent a time period of a calendar year; and/or wherein each time slot of the plurality of time slots is configured to represent a time interval of between 15 minutes and 3 hours, preferably between 30 minutes and 2 hours; more preferably 1 hour.

In a fifth aspect according to any one of aspects 1 to 4, each zone of the plurality of zones defines a region in which a demand for vehicles is substantially homogeneous.

In a sixth aspect according to any one of aspects 1 to 5 in combination with aspect 3, for each time slot of the plurality of time slots one or more properties of one or more of the zones of the plurality of zones is subject to change: a size of the respective zone of the one or more of the zones; a region covered by the respective zone of the one or more of the zones; and a respective predicted demand for the respective zone of the one or more of the zones.

In a seventh aspect according to any one of aspects 1 to 6, determining the relocation requirement for each zone of the plurality of zones is triggered: at a predetermined interval, preferably the predetermined interval being between 30 minutes and 2 hours; more preferably between 45 minutes and 75 minutes; most preferably about 1 hour; when adding an inactive vehicle to the plurality of vehicles, an inactive vehicle denoting a vehicle previously not included in the plurality of vehicles and designated to be considered for use; and/or when removing an active vehicle from the plurality of vehicles, an active vehicle denoting a vehicle currently included in the plurality of vehicles and designated to not be considered for use.

In an eighth aspect according to any one of aspects 1 to 7 in combination with aspect 3, determining for each zone of the plurality of zones the respective predicted demand includes determining for each zone of the plurality of zones the respective predicted demand for each time slot of the plurality of time slots; optionally wherein determining for each zone of the plurality of zones the respective predicted demand is repeated at a regular interval, preferably the regular interval being between 30 minutes and 2 hours; more preferably between 45 minutes and 75 minutes; most preferably about 1 hour.

In a ninth aspect according to any one of aspects 1 to 8, the one or more vehicles to be relocated are of human-operated type and, in each of the one or more vehicles, the relocation instruction is executed by a respective human operator in control of the respective vehicle; preferably wherein the respective human operator is a user of the respective vehicle.

In a tenth aspect according to any one of aspects 1 to 8, the one or more vehicles to be relocated are of an autonomous type and, in each of the one or more vehicles, the relocation instruction is executed by a respective control unit configured to control the respective vehicle.

The accompanying drawings disclose exemplifying and non-limiting aspects in accordance with embodiments of the present invention. In the drawings, like reference numerals denote the same, similar, or identical components.

### BRIEF DESCRIPTION OF THE DRAWINGS

FIG. 1 schematically shows a system for relocating vehicles in accordance with embodiments of the present disclosure.

FIG. 2 illustrates an example zoning of an operating area for use with a system for relocating vehicles in accordance with embodiments of the present disclosure.

FIGS. 3A to 3C illustrate example relocations during different phases for a vehicle being relocated in accordance with embodiments of the present disclosure.

FIG. 4 shows a flow chart of a method for relocating vehicles in accordance with embodiments of the present invention.

### DETAILED DESCRIPTION OF THE DRAWINGS

In the following detailed description, unless specifically stated otherwise, identical, same, or similarly functioning elements are denoted using identical reference numerals.

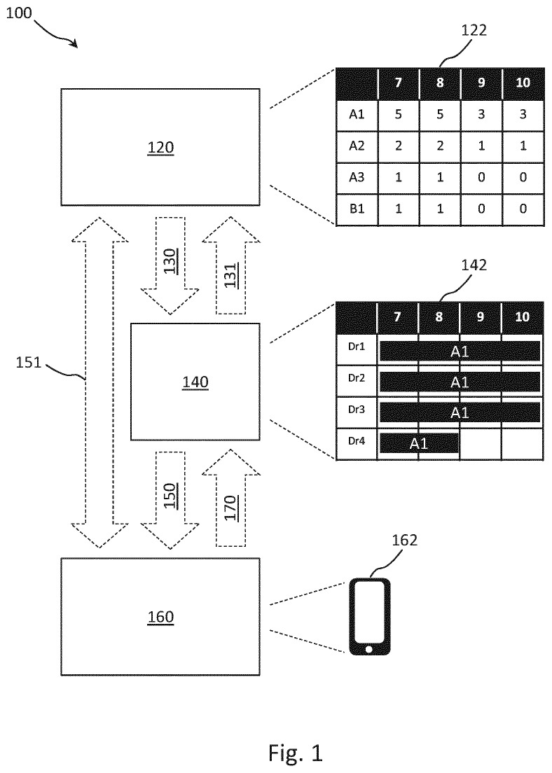

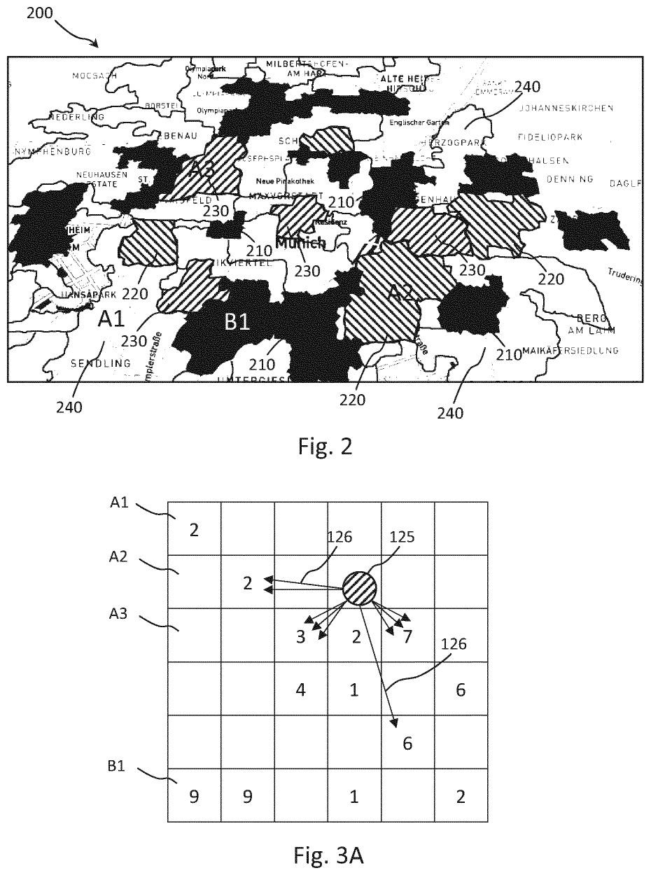

FIG. 1 schematically shows a system 100 for relocating vehicles in accordance with embodiments of the present disclosure. Generally, the system 100 is configured for providing a supply plan for vehicles in an operating area 200 (see. FIG. 2), for monitoring a plurality of zones within the operating area 200 and, in particular, for monitoring and determining a distribution of vehicles across the different zones, as well as for determining when one or more vehicles should be relocated in order to achieve the distribution.

As shown in FIG. 1, the system 100 may include an ODM unit 120, a planning and communication unit 140, and a client unit 160. The ODM unit 120 is configured for determining a demand prediction, for determining a planned supply of vehicles, and/or for providing prediction and/or planning data. The ODM unit 120 is typically operated by a provider of the vehicles of the shared fleet. ODM unit 120 may further be configured to provide interface services (e.g. upload/download functionality of platform output, e.g. weekly supply plan or predictions per day and hour). In particular, the interface services provide the download functionality of supply plans (i.e. predicted demand) per hour of day and zone.

The planning and communication unit 140 is configured for one or more of the following: providing calendar services, providing scheduling services (e.g. start/end shift reminders), accounting services (e.g. break deductions, paycheck calculations), management services (e.g. driver availability incorporation, shift claiming option).

It is noted that functionality may be shifted from unit 120 to unit 140 and vice versa, depending on a respective implementation. The functionality described herein corresponds to an exemplary embodiment. In other embodiments one or more functions may be shifted between units 120 and 140 and/or other components of the system 100 as desired or if prompted by a particular application.

The predicted values could be adapted by the human fleet manager for some exceptional (e.g. abnormal or extraordinary) cases, such as public transportation strike or similar events, which are not modelled in the demand prediction algorithm. The planning and communication unit 140 may be operated by the provider of the vehicles (e.g. when operating a fleet of autonomous vehicles) or by a provider of human operators.

The client unit 160 is configured for providing services and/or data to the vehicles and/or operators of the vehicles. The services include one or more of providing map data pertaining to the operating area and the zones included therein, providing a user interface (e.g. for inputting manual adjustments), tracking and monitoring services (e.g. tracking of key performance indicators (KPI), driver information), and operating services (e.g. estimated time of arrival (ETA) information for individual rides/pickups, information about pickups and predicted pickups, demand fulfilment). Zones may be sized and shaped as desired, for example depending on feature density, traffic density, usage density, and other factors. The size of zones may, in particular, be reduced in order to increase modelling precision.

The ODM unit 120 may create, update, and/or maintain a database 122 configured to store zone and time information. In the example depicted in FIG. 1, the database 122 is shown as a collection of records mapping individual zones (e.g. A1, A2, A3, B1, . . . ) and time slots (e.g. 7, 8, 9, 10, . . . ) to a value indicative of a predicted demand. The records store a demand prediction (e.g. “5”) for a respective zone (e.g. “A1”) and time slot (e.g. “8”). The demand prediction may include any metric suitable for representing a predicted demand, for examples as a quantity of vehicles required. As shown, the demand in zone A1 for the time period ranging from time slot 7 to time slot 10 is 5, 5, 3, and 3, thereby indicating a predicted demand that is falling from 5 vehicles to 3 vehicles over time. There may be zones exhibiting a predicted demand of zero (see, e.g., zones A3 and B1 at time slots 9 and 10), indicating that the predicted demand for the respective zones and time slots is zero vehicles. Time slots may correspond to discrete time periods (e.g. 30 minutes, 1 hour) and may also vary in size. For example, during times of low demand (e.g. after 2 am) it may be more efficient to model the time slots as longer intervals (e.g. 1 hour or 2 hours) whereas during times of high demand and/or times where demand is predicted to fluctuate (e.g. during rush hour in the mornings or evenings) it may be more efficient to model the time slots as shorter intervals (e.g. 10 minutes, 20 minutes, 30 minutes).

The ODM unit 120 may be configured to provide 130 a downloaded matrix of zone(s) and time slot(s) 122 for the entire week to the planning and communication unit 140. The matrix 122 can be uploaded into a shift planning tool. The planning tool may implement an API link providing shifts to drivers based on the information shared in 130 (zone and hour). The planning and communication unit 140 adds drivers to shifts.

The planning and communication unit 140 may create, update, and/or maintain a database 142 configured to store vehicle/driver and time information. In the example depicted in FIG. 1, the database 142 is shown as a collection of records mapping individual vehicles or drivers (Dr1, Dr2, Dr3, Dr4, . . . ) and time slots (7, 8, 9, 10, . . . ) to time slots the vehicle or driver should be available. As shown, for example for vehicle/driver “Dr1”, the respective vehicle should be available during time slots 7, 8, 9, and 10. As soon as a vehicle/driver should be “onshift” or “offshift” this is reflected in database 140. Available drivers are located and/or be relocated to another zone, this is reflected in the database of the ODM unit 120.

In particular, the ODM unit 120 is configured to provide the zone information and the planning and communication unit 140 is configured to keep track of the basic availability of drivers/vehicles. For example, driver Drx is scheduled to start at 7:00 am with a shift and end the shift at 10:00. Once driver Drx starts the shift, unit 120 sends the zone information to the driver Drx. Unit 140 may implement a basic shift planning tool that is configured to perform the shift planning based on demand prediction and driver/vehicle availability restrictions. Shifts are then pushed to the client unit 160.

In a preferred embodiment, the implementation may include that unit 120 is configured to communicate zones to a driver as soon as the driver goes “onshift”. A driver may be available because a driver vendor planned their shift based on data provided by unit 120 (e.g. by upload of a table or spreadsheet into the system 100). An important parameter is the total number of drivers available per time slot.

In another preferred embodiment, the implementation may include that unit 140 is configured to automatically create shifts/vehicle availability based on information from ODM unit 120. Unit 140 then pushes shifts to drivers/vehicles on client units 160 and may be configured to schedule maintenance and cleaning tasks during not scheduled times.

The ODM unit 120 may be configured to provide 151, for example, zone information, information regarding a meeting point within the zone, and time information to the client unit 160. Once a driver is online (e.g. shift planned in unit 140) the ODM unit 120 handles all trip and zone locations. Additionally or alternatively, the planning and communication unit 140 and the ODM unit 120 may be configured to receive 170, 151, 131 KPIs from the planning and communication unit 140 and from the client unit 160. The KPIs may include one or more of the following: duration of relocation, percentage of successful relocations per driver, percentage of delayed relocations per driver, length of relocation, reason for relocation, number of relocations per hour, number of relocations per zone, relocation delay per driver, and other. In other words, ODM unit 120 is communicating with the driver while 140 is configured for shift planning based on input 130 provided by ODM unit 120.

FIG. 2 illustrates an example zoning of an operating area 200 for use with a system 100 for relocating vehicles in accordance with embodiments of the present disclosure. The operating area 200 may comprise an urban environment and may be delimited by any structural, natural, regulatory, or other suitable metric. Typically, the operating zone is determined based on expected demand which may or may not correlate to an existing urban zone. Therefore, the operating area may cover only a portion of an urban area and/or extent beyond city limits depending upon the individual application.

FIG. 2 shows operating area 200 including zones 210, 220, 230, and 240 (for clarity, not all zones are provided with reference numerals). The zones 210, 220, 230, and 240 denote different predicted demand for the ODM application. For example, the predicted demand may be the highest in zones 210 and the lowest in zones 240, while zones 220 and 230 denote an intermediate demand with zones 220 being indicative of a higher demand than zones 230. The distribution of zones 210, 220, 230, 240 is merely exemplary and predicted demand may fluctuate over time. Further, the shape, form, size, and location of zones 210, 220, 230, 240 may fluctuate over time, such that zones may grow, shrink, shift their position or shape, and/or cease to exist or be created based on a predicted demand. One key concept of any zone 210, 220, 230, and 240 is that the predicted demand is homogeneous over the region covered by the respective zone. In an example, a particular zone could be a zone exhibiting prevailing outgoing rides at a certain time of day (e.g. in the morning), for example a residential zone. In another example, another zone could exhibit prevailing incoming rides during the same time, for example a commercial zone. In general, a comparison for similarity may be based on one or more of multiple features (e.g. incoming and/or outgoing rides per hour). Further, clustering and/or Voronoi-based processing of such features may be carried out.

With respect to FIG. 1, each of the zones A1, A2, A3, B1, . . . , is associated with exactly one of the zones 210, 220, 230, 240 shown in FIG. 2. It is noted that for reasons of clarity, only some zones shown in FIG. 2 have been provided with respective reference numerals A1, A2, A3, and B1. It is understood that any desired zoning and association of zones to predicted demand may be implemented in order to achieve the respective mapping of zones and times to predicted demand. When a vehicle and/or driver are relocated, the vehicle and/or driver may be prompted or instructed to move from one zone (e.g. zone A1 with low demand) to another zone (e.g. zone B1 with high demand).

Prediction of demand for each zone over time, as well as the size, shape, position, etc. of a zone over time are determined based on one or more of the following: historical booking data, INFAS structural data including information regarding residents/households aggregated per 200 households and information about type of area (e.g. residential vs. commercial buildings percentage), POIs (e.g. provided by Google, OSM) including public transportation. The zoning is configured to provide zones with homogeneous demand. Prediction of demand per zone is based on the historical booking data, INFAS data, data provided by Google and Open Street Map (OSM) POIs, weather data, event data (e.g. concerts, soccer games, or similar events), app data (including proprietary app data, e.g. DriveNow/ShareNow), and other data.

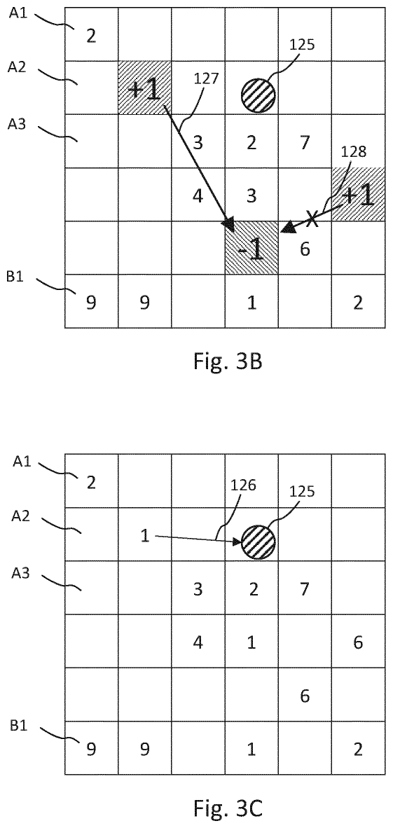

FIGS. 3A to 3C illustrate example relocations during different phases for a vehicle being relocated in accordance with embodiments of the present disclosure. In each of FIGS. 3A to 3C, the fields in the matrix represent zones (see, e.g., FIG. 3A, zones A1, A2, A3, . . . ) and a numeric value in a field denotes an actual number of vehicles or a predicted demand of vehicles in a respective zone. Generally, the predicted demand and the actual number of vehicles in a zone should be identical for most zones, so that an expected demand can be efficiently met.

FIG. 3A illustrates a relocation situation typical for an operating phase where vehicle is commissioned into service (e.g. after cleaning, maintenance, re-fueling/charging) or when a human driver starts a shift (e.g. at the beginning of a workday or after taking a break). In the example shown, one or more vehicles start operating at a station 125. For fleets of autonomous vehicles, station 125 may be a vehicle depot, parking area, maintenance area, refueling/charging area, or any other facility that may be associated with an autonomous vehicle. For human operated vehicles, station 125 may exhibit the same properties as for autonomous vehicles. Alternatively, in particular when human operators provide their own individual vehicles, station 125 may represent a home location for the respective human operator and each human operator may, thus, have their own station 125. In an application, where one or more autonomous vehicles are operated by one or more providers, each provider may have one or more stations 125, each station being associated with one or more vehicles. In vehicle sharing applications, a station 125 may include a previous destination of a respective vehicle, for example when the system 100 is applied to fleets of floating vehicles (i.e. without a designated station and/or parking area).

Each vehicle may start at an assigned station 125 or at a respective “home” station. An assigned station may be provided based on predicted demand, such that vehicles are commissioned into service, they are deployed in an area with corresponding predicted demand. In this manner, vehicles are distributed in a desired manner over the operating area and the respective zones (see arrows 126). While being relocated, each vehicle is denoted as an active ride until the respective destination is reached. The relocation is completed as soon as a vehicle crosses the border to a zone that the vehicle is designated to be located in. FIG. 3A illustrates a situation in which vehicles have been relocated as desired so that a predicted demand is matched (i.e. that in each zone a desired number of vehicles is present).

FIG. 3B illustrates a relocation situation typical for a regular operating phase when vehicles and/or drivers are available for service (e.g. during a shift). Hatched zones (see “+1” and “−1”) denote zones in which there is a surplus of one or more vehicles or in which one or more vehicles are needed. As soon as the actual number of vehicles in a zone is lower than a predicted demand in that zone, a relocation (request) into that zone is triggered (see “−1”). Similarly, as soon as the actual number of vehicles in a zone is higher than a predicted demand in that zone, a relocation (request) from that zone is triggered (see “+1”). In case of a relocation 128, a first vehicle and/or driver is requested to relocate to another zone. The relocation 128 may be triggered by falling demand (e.g. from 6, see FIG. 3A, to 5) or by an additional vehicle becoming available in that zone (e.g. the number of vehicles rising from 6 to 7). Both examples would lead to a surplus of vehicles in that zone, indicated by a “+1”.

The predicted demand and/or the relocation of vehicles/drivers may be triggered at regular intervals, for example between 30 minutes and 2 hours, preferably 45 to 75 minutes, most preferably about 1 hour. The interval should not be too long or too short, with too long intervals allowing for substantial buildup of relocation demand and too short intervals potentially triggering relocations too often (e.g. causing extra costs). The predicted demand may be determined at shorter intervals, in order to quickly identify a growing or falling demand. Relocation may be triggered when a threshold value for predicted demand is crossed (e.g. meeting a certain minimum necessity for relocation of vehicles/drivers). In applications for autonomous vehicles, intervals may generally be reduced in order to effectively use the fleet of autonomous vehicles.

In FIG. 3B the relocation is shown as a zone having fewer vehicles/drivers than a predicted demand, indicated by “−1”. In addition, another zone may indicate that there is a surplus of vehicles/drivers, indicated by “+1”. During this process, it is possible that a second vehicle and/or driver has an active ride 127 (e.g. transporting a paying customer) with a destination in the zone that the first vehicle and/or driver is being relocated to. As shown in FIG. 3B, the two different zones have a surplus of “+1” vehicles. In such a case, the relocation 128 may be cancelled and the active ride 127 of the second vehicle/driver may be treated as a replacement for the relocation 128 of the first vehicle/driver. In this manner, it is possible to reduce or minimize the number of relocations and/or associated costs. It is noted that any demand for vehicles in a zone (e.g. “−1”, “−2”, “−3”, etc.) and/or any surplus of vehicles in a zone (e.g. “+1”, “+2”, “+3”, etc.) may be taken into consideration, whereas from one zone with a surplus vehicles may be relocated to different zones as long as there is a (residual) surplus (e.g. from a “+3” zone, up to three vehicles may be relocated to one or more different zones).

Generally, vehicles/drivers may be assigned to different zones upon completing an active ride, for example back to a zone the ride started in, the zone that the destination is located in, a zone that needs additional vehicles, or any other zone as per an automatically generated or manually determined schedule. In particular, the predicted demand and/or zones may change, which can also trigger a relocation.

FIG. 3C illustrates a relocation situation typical for an operating phase where vehicle is completing its service (e.g. when cleaning, maintenance, or re-fueling/charging is due) or when a human driver ends a shift (e.g. at the end of a workday or when taking a break). The respective vehicle/driver may return to an assigned or home station 125. The vehicle/driver may further mark themselves as being “offline” (i.e. not available for service) and, thus, not appear in the system 100 during the transition 126 to the station 125.

Relocation may be determined based on a generic algorithm. For example, if the problem cannot be solved in an exact manner due to problem size, a genetic algorithm is preferred.

The genetic algorithm in accordance with embodiments of the present disclosure is based on a formulation of an optimization problem for an effective relocation of the ride hailing fleet at runtime of the business. Premises for the approach include an assignment of resources to entities which have a demand for the respective resource and a determination of a minimal cost for an assignment based on a self-defined cost function.

In an exemplary embodiment, the cost function is defined as follows:

$$\begin{matrix}min \text{:} {\sum }_{i = 1}^{m} {\sum }_{j = 1}^{n} {c}_{ij} {x}_{ij} & \\ s . t . & \\ {x}_{ij} ∈ \{ 0 , 1 \} & ( 1 ) \\ {\sum }_{j = 1}^{n} {x}_{ij} = {a}_{i} = 1 , i = 1 , 2 , … , m & ( 2 ) \\ {\sum }_{i = 1}^{m} {x}_{ij} = {b}_{j} , j = 1 , 2 , … , n & ( 3 )\end{matrix}$$

where cᵢⱼ=cost for moving from i to j, aⱼ=supply of vehicle i (i=1, . . . , m), and bⱼ=demand of zone j.

In a first example use case (e.g. rush hour), requirements include that vehicles are placed at locations with customer demand as quickly as possible and that a distribution of surplus vehicles be substantially uniform over the operating area. Working costs (e.g. gasoline usage, toll, increased wear) due to longer routes being travelled may be disregarded or be provided with a low weight.

The multiple-objective optimization is as follows:

$$\begin{matrix}min \text{:} {\sum }_{i = 1}^{m} {\sum }_{j = 1}^{n} {t}_{ij} {x}_{ij} & \\ s . t . {x}_{ij} ∈ \{ 0 , 1 \} & ( 1 ) \\ {\sum }_{j = 1}^{n} {x}_{ij} = {a}_{i} = 1 , i = 1 , 2 , … , m & ( 2 ) \\ {\sum }_{i = 1}^{m} {x}_{ij} = {b}_{j} , j = 1 , 2 , … , n & ( 3 ) \\ {\sum }_{j = 1}^{n} {( {b}_{j} - {\sum }_{i = 1}^{m} {x}_{ij} )}^{2} < {ɛ}_{dist} & ( 4 )\end{matrix}$$

based on the ε-constraint method, where Σᵢ₌₁^{m} xᵢⱼ represents the number of vehicles which are assigned to zone j.

In a second example use case (e.g. non-rush hour), requirements include that a relocation be cost-efficient, a distribution of vehicles to zones associated with higher or highest profit is performed, and that unnecessary relocations or trips be minimized or prevented. Working costs (e.g. gasoline usage, toll, costs per distance travelled) may be prioritized or provided with a high weight.

A cost function may be based on the stated working costs and fixed costs:

$${c}_{ij} = \{ \begin{matrix}{c}_{ij} , & {x}_{ij} = 0 \\ {c}_{ij} + {c}_{fix} , & {x}_{ij} = 1\end{matrix}$$

A linear optimization may be performed as follows:

$$\begin{matrix}min \text{:} {\sum }_{i = 1}^{m} {\sum }_{j = 1}^{n} {c}_{ij} {x}_{ij} - {\sum }_{j = 1}^{n} ( max ( 0 , {\sum }_{i = 1}^{m} {x}_{ij} - {b}_{j} ) * avg . {revenue}_{j} ) & \\ s . t . & \\ {x}_{ij} ∈ \{ 0 , 1 \} & ( 1 ) \\ {\sum }_{j = 1}^{n} {x}_{ij} = {a}_{i} = 1 , i = 1 , 2 , … , m & ( 2 ) \\ {\sum }_{i = 1}^{m} {x}_{ij} = {b}_{j} , j = 1 , 2 , … , n & ( 3 )\end{matrix}$$

The genetic algorithm employed belongs to the class of evolutionary algorithms (e.g. a class of Meta-Heuristics). It is based on the imitation of processes of biological evolution on an abstract level, including the use of encoded representations of the solution space, an evolving population of solutions to cover the search space, an evaluation based on a fitness function, and an exploitation of probabilistic rules to find new solutions.

Relocation may alternatively be determined based on an optimization. For example, the relocation problem may be modelled using the high-level constraint programming language MiniZinc and a corresponding MiniZinc program (e.g. a model compiled into FlatZinc) may be solved by a suitable solver (e.g. OSI-CBC).

In some embodiments, relocations may be determined in different ways (see above) depending upon one or more factors, including zone properties, predicted demand, fleet properties, and/or time.

In some embodiments, there may be default measures in place for time periods where communication is interrupted (e.g. when travelling through a tunnel) or when no relocation request is available. In this manner, a vehicle/driver may relocate to a default zone unless instructed otherwise.

Depending on the individual application, the relocation information may be conveyed directly to a control unit of the vehicle, in particular for autonomous vehicles, or to a user device used by a human operator (i.e. driver).

In a preferred embodiment, relocations are triggered at least based on the following factors. In case of a single vehicle/driver, as relocation may be triggered at the beginning and end of service, after completion of a ride, or when a manual relocation is triggered (e.g. by a scheduler or a human operator). In case of multiple relocations of a fleet of vehicles, a relocation may be triggered at regular (or adapted) intervals (e.g. 10 minutes to 1 hour), after every change in a supply plan (e.g. indicative of a predicted demand), when any vehicle/driver goes out of service (or “offline”), and if any zone drops below a minimum number of vehicles (e.g. less than a predicted or actual demand).

In some embodiments, when more vehicles/drivers are available than necessary to serve all zones, the system 100 may relocate surplus vehicles/drivers to zones where a predicted demand will rise in one or more subsequent time slots.

In some embodiments, when less vehicles/drivers are available than necessary to serve all zones, the system 100 may be configured to prioritize some zones based on a scheme configured to provide more frequented zones with a higher priority. In this manner, available vehicles/drivers can be relocated to zones where a predicted demand is higher than a current number of vehicles/drivers available and where a high number of requests is expected. This may entail that an average utilization of vehicles/drivers is maximized or optimized.

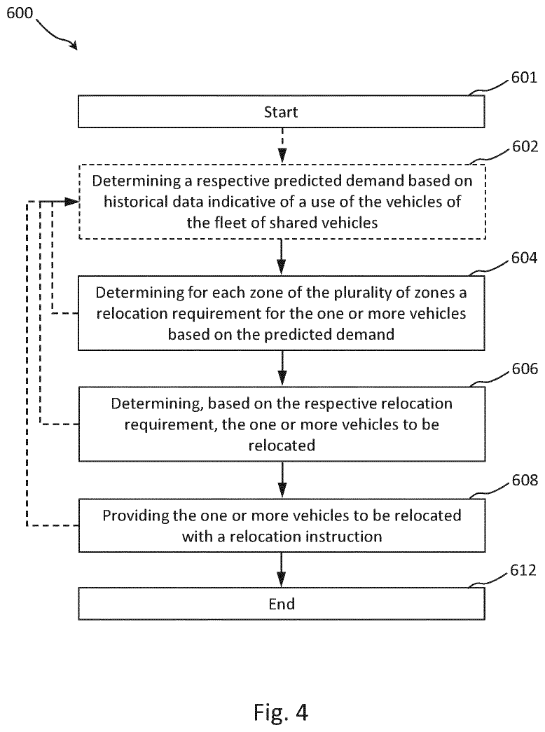

FIG. 4 shows a flow chart of a method 600 for relocating vehicles in accordance with embodiments of the present invention. The method 600 for relocating one or more vehicles of a fleet of shared vehicles is applied to an operating area 200 in which the one or more vehicles are operated. The operating area 200 includes a plurality of zones, each zone A1, A2, A3, B1 of the plurality of zones being configured to designate a portion of the operating area. The method starts at step 601.

In an optional step 602, for each zone A1, A2, A3, B1 of the plurality of zones, a respective predicted demand is determined based on historical data indicative of a use of the vehicles of the fleet of shared vehicles. Step 602 may be based on other data and/or include alternative or additional steps in order to determine a predicted demand. In preferred embodiments, step 602 is performed repeatedly and/or at regular intervals in order to continuously and/or regularly determine a predicted demand. In some embodiments, step 602 may be performed as desired, for example after any one of steps 604, 606, and 608 (see dashed arrows).

In step 604, for each zone of the plurality of zones, a relocation requirement is determined for the one or more vehicles based on the predicted demand. The predicted demand includes, for each zone of the plurality of zones, a respective demand indicative of a demand for vehicles in the respective zone. Similar to step 602, step 604 may, in preferred embodiments, be performed repeatedly and/or at regular intervals in order to continuously and/or regularly determine a relocation requirement. In FIG. 4, dashed arrows leading back to optional step 602, also indicate repeatedly and/or regularly performing step 604, with or without performing optional step 602.

In step 606, based on the respective relocation requirement, the one or more vehicles to be relocated are determined.

In step 608, the one or more vehicles to be relocated are provided with a respective relocation instruction. It is noted that, as described above, relocation instructions may be provided to a corresponding client unit 160 and/or to a control unit in the respective vehicle. In preferred embodiments, relocation instructions may be provided to a control unit in a corresponding autonomous vehicle.

In preferred embodiments, method 600 is continuously performed, so that after any one of steps 604, 606, and 608, step 604—optionally preceded by step 602—is performed again.

Method 600 ends at step 612.

1.-10. (canceled)

11. A method for relocating one or more vehicles of a fleet of shared vehicles in an operating area, the operating area including a plurality of zones, each zone of the plurality of zones being configured to designate a portion of the operating area, the method comprising:
determining, for each zone of the plurality of zones, a relocation requirement for the one or more vehicles based on a predicted demand, the predicted demand including, for each zone of the plurality of zones, a respective demand indicative of a demand for vehicles in the respective zone;
determining, based on the respective relocation requirement, the one or more vehicles to be relocated; and
providing the one or more vehicles to be relocated with a relocation instruction.

12. The method of claim 11, further comprising:
determining, for each zone of the plurality of zones, the respective predicted demand based on historical data indicative of a use of the vehicles of the fleet of shared vehicles.

13. The method of claim 11, wherein the predicted demand includes a plurality of predicted demand values, and each predicted demand value of the plurality of predicted demand values is associated with a time slot of a plurality of time slots.

14. The method of claim 13, wherein at least one of:
the plurality of time slots is configured to represent a time period of a calendar year; or
each time slot of the plurality of time slots is configured to represent a time interval of between 15 minutes and 3 hours.

15. The method of claim 14, wherein the time interval is between 30 minutes and 2 hours.

16. The method of claim 14, wherein the time interval is 1 hour.

17. The method of claim 11, wherein each zone of the plurality of zones defines a region in which the demand for vehicles is substantially homogeneous.

18. The method of claim 13, wherein for each time slot of the plurality of time slots, one or more of the following properties of one or more of the zones of the plurality of zones is changeable:
a size of the respective zone of the one or more of the zones;
a region covered by the respective zone of the one or more of the zones; and
a respective predicted demand for the respective zone of the one or more of the zones.

19. The method of claim 11, wherein determining the relocation requirement for each zone of the plurality of zones is triggered at least one of:
at a predetermined interval, wherein the predetermined interval is between 30 minutes and 2 hours,
when adding an inactive vehicle to the plurality of vehicles, the inactive vehicle denoting a vehicle previously not included in the plurality of vehicles and designated to be considered for use, or
when removing an active vehicle from the plurality of vehicles, the active vehicle denoting a vehicle currently included in the plurality of vehicles and designated not to be considered for use.

20. The method of claim 19, wherein the predetermined interval is between 45 minutes and 75 minutes.

21. The method of claim 19, wherein the predetermined interval is about 1 hour.

22. The method of claim 13, wherein determining, for each zone of the plurality of zones, the respective predicted demand includes determining, for each zone of the plurality of zones, the respective predicted demand for each time slot of the plurality of time slots.

23. The method of claim 22, wherein determining, for each zone of the plurality of zones, the respective predicted demand is repeated at a regular interval.

24. The method of claim 23, wherein the regular interval is between 30 minutes and 2 hours.

25. The method of claim 23, wherein the regular interval is between 45 minutes and 75 minutes.

26. The method of claim 23, wherein the regular interval is about 1 hour.

27. The method of claim 11, wherein the one or more vehicles to be relocated are of human-operated type and, in each of the one or more vehicles, the relocation instruction is executed by a respective human operator in control of the respective vehicle.

28. The method of claim 27, wherein the respective human operator is a user of the respective vehicle.

29. The method of claim 11, wherein the one or more vehicles to be relocated are of an autonomous type and, in each of the one or more vehicles, the relocation instruction is executed by a respective control unit configured to control the respective vehicle.
